(19) United States
(12) Patent Application Publication
(10) Pub. No.: US 2006/0008320 A1
(43) Pub. Date: Jan. 12, 2006

(54) Scrapbook rack organizer

(75) Inventor: Tiffany Spaulding, Tacoma, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Triple-T Designs, Inc., Tacoma, WA (US)

(21) Appl. No.: 11/171,641

(22) Filed: Jun. 30, 2005

Related U.S. Application Data
(60) Provisional application No. 60/584,118, filed on Jun. 30, 2004.

(51) Int. Cl. B42F 13/00

(52) U.S. Cl. 402/79

(57) ABSTRACT

The present invention provides an organizational device and a kit comprising components of an organizational device and instructions for assembly. The organizational device has a base unit that includes a central panel. Left- and right-wing panels are removably attached to the central panel. At least one binder unit is also removably attached to the central panel. The organizational device may also have at least one storage page that is removably received in the binder unit. The organizational device may further include a support member attached to the central panel for supporting the central panel at an acute angle. The organizational device is useful for arranging, sorting, storing, and transporting all means of printed materials and crafting supplies. In another aspect, the invention provides a storage page with a crescent-shaped flap that may be used with the organizational device and system.

### CROSS-REFERENCE TO RELATED APPLICATION

The present application claims the benefit of U.S. Patent Application No. 60/584,118, filed on Jun. 30, 2004.

### FIELD OF THE INVENTION

The present invention relates to an organizational device and, more particularly, to a multi-binder organizational device.

### BACKGROUND OF THE INVENTION

Various attempts have been made at providing an organized means for arranging keepsakes and craft supplies; however, such methods do not allow organization and easy retrieval of items such that each of the items may be separately stored and retrieved while retaining the organization of the remaining items.

Therefore, a need exists for an improved means for organizing keepsakes and craft supplies that allows a user to easily locate and access the stored items.

### SUMMARY OF THE INVENTION

The present invention provides an organizational device and a kit comprising components of an organizational device. In one embodiment, the organizational device has a base unit that includes a central panel. Left- and right-wing panels are removably attached to the central panel. At least one binder unit is also removably attached to the central panel. The organizational device also may include at least one storage page that is removably received in the binder unit. The organizational device may further include a support member attached to the central panel for supporting the central panel at an acute angle. The organizational device is useful for arranging, sorting, storing, and transporting all means of printed materials and crafting supplies. There are many advantages of the organizational device, including the ability to easily access stored materials due to the convenient configuration of the base unit and the ability to easily remove and reattach a binder that binds multiple storage pages.

In another aspect, the invention provides a variety of storage pages, each with a crescent-shaped flap that secures a stored item. The storage pages may be used with the organizational device and kit.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagram illustrating an organizational device comprising a base unit including a central panel with an attached support member and attached wing panels, in accordance with an embodiment of the present invention;

FIG. 2 is a diagram illustrating the organizational device including multiple binders that are removably attached to the central panel;

FIG. 3 is a diagram illustrating the components used to make the base unit and wing panels attachable to the base unit to form a representative embodiment of the organizational device;

FIG. 4 is a diagram of a storage page with a single storage pocket having a crescent-shaped flap;

FIG. 5 is a diagram of a storage page with two storage pockets having individual crescent-shaped flaps;

FIG. 6 is a diagram of a storage page with six storage pockets having individual crescent-shaped flaps; and

FIG. 7 is a diagram of an organizational device useful for travel, the device including a central panel with a removably attached binder unit in accordance with an embodiment of the present invention.

### DETAILED DESCRIPTION OF THE PREFERRED EMBODIMENT

Generally described, the present invention provides an organizational device for arranging, sorting, storing, and transporting all means of crafting supplies and printed materials. The concept is to provide a tool that will allow easy access to frequently used materials, whether they are for crafting or reference. The organizational device has a base unit, two attachable wing units, and at least one binder unit that is removably attached to the central panel of the base unit. The organizational device may also have at least one storage page that is removably received in the binder unit. The organizational device can be used to organize any crafting supplies, (i.e., supplies for quilters, toll painters, card makers, rubber stampers, and the like), and can also be used to organize and/or display any printed materials such as photographs, mementos, greeting cards, recipes, and the like.

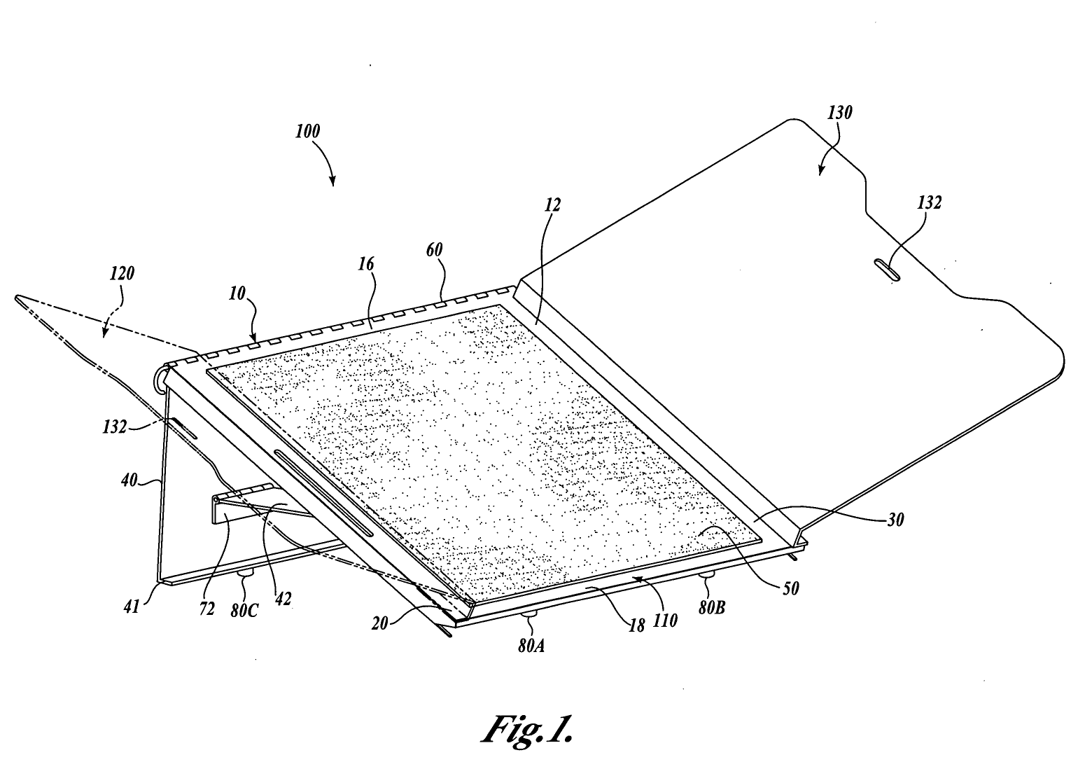

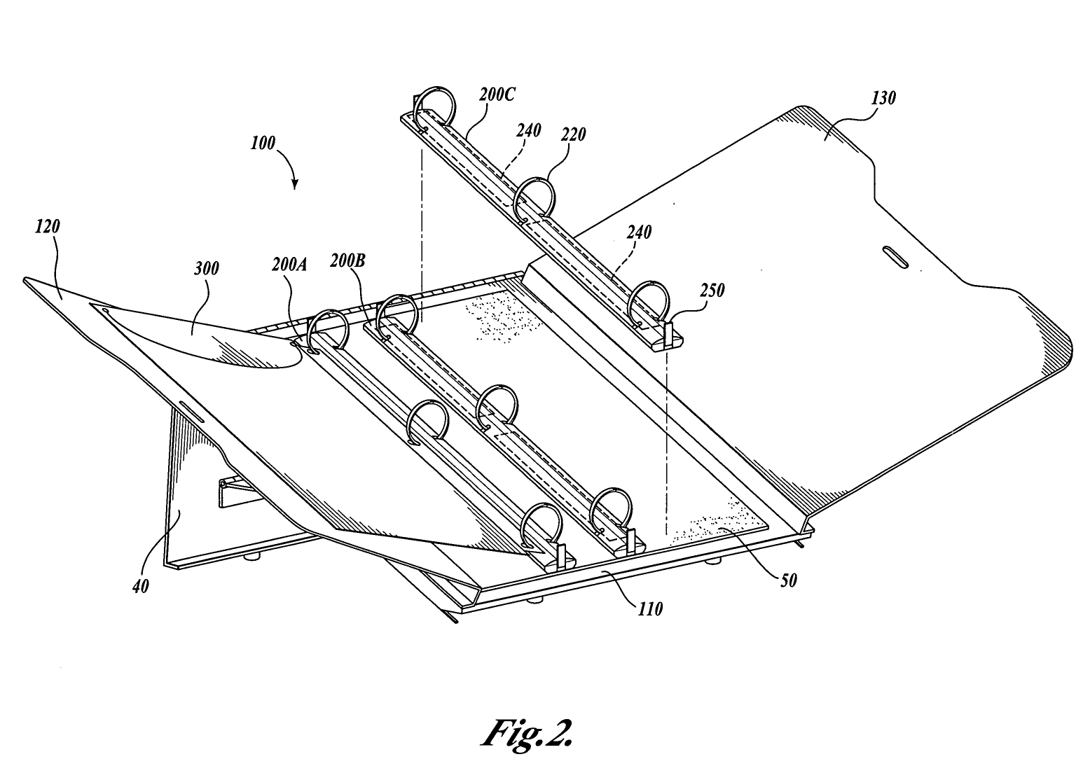

FIG. 1 is a diagram of an embodiment of an organizational device 100 including a base unit 10 having a central panel 110. The central panel 110 has a front side 12, a back side 14 (hidden from view), a top edge 16, a bottom edge 18, a left edge 20, and a right edge 30. The central panel 110 may be formed in various shapes and dimensions. In the embodiment shown in FIG. 1, the central panel 110 is substantially rectangular. A removably attachable left wing panel 120 and a removably attachable right wing panel 130 may be additionally attached to the central panel 110, as shown in FIG. 1. At least one binder unit 200 is also removably attached to the central panel 110. The organizational device 100 thus further includes an attachment assembly 50, 240 for removably securing the binder 200 and the central panel 110 together. Hence, the front side 12 of the central panel 110 includes means 50 for removably securing at least one binder unit 200 (shown best in FIG. 2). The attachment assembly 50, 240 may include any suitable structure capable of interconnecting the attachment assembly 50 included on the central panel 110 with a corresponding attachment assembly 240 included on the binder unit 200, such as, for example, hook and loop fasteners such as Velcro®, magnetic elements, interlocking tabs, snaps, zippers, and the like.

In one embodiment, the organizational device 100 may further include a support member 40 that is attached with attachment means, either fixedly or removably, to the central panel and capable of supporting the central panel 110 such that it rests at an acute angle on a planar surface. The removable attachment means for attaching the support member 40 to the central panel 110 may be any suitable structure, such as, for example, hinge elements, hook and loop fasteners, magnetic elements, interlocking tabs, snaps, zippers and the like. In some embodiments of the organizational device 100, the support member 40 is fixedly attached to the central panel 110 with a flexible attachment element, such as a flexible plastic material or other suitable attachment element to form a flap for easy storage and assembly.

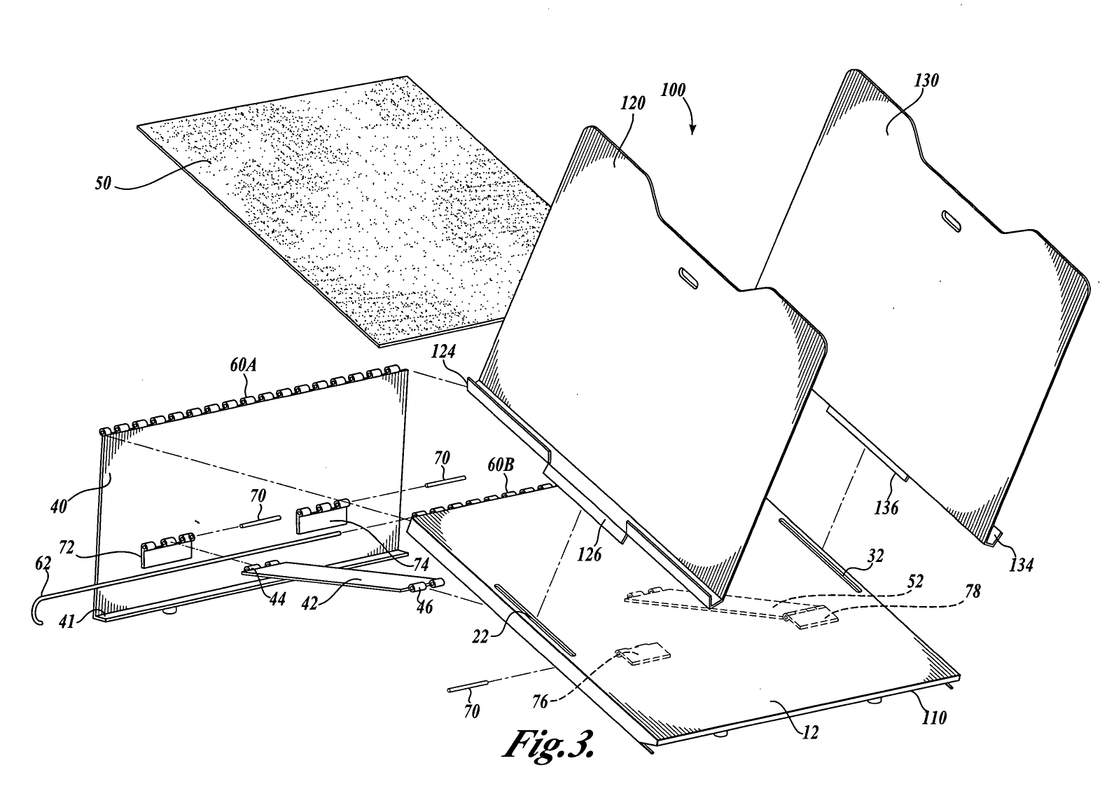

A representative example of the device 100 including the support member 40 is shown in FIG. 1. In the embodiment of the device 100 shown in FIG. 1, the top of the support member 40 is removably attached to the top edge 16 of the central panel 110 with a hinge 60 formed from interlocking hinge elements 60A, 60B that are secured with a hinge pin 62 (shown best in FIG. 3).

As mentioned above, the organizational device 100 includes the attachment assembly 50 for detachably securing a plurality of binder units. As shown in FIG. 2, in one embodiment of the device 100, a portion of the front side 12 of the central panel 110 is covered with “hook-side” Velcro® 50. The organizational device 100 may include at least one, and preferably multiple, binder units 200A, 200B and 200C that are removably attached to the Velcro® section 50. Each binder unit 200A-C is capable of receiving one or more storage pages 300. Included on a back portion of each binder 200A-C is a region of “eye-side” Velcro®240. In the embodiment of the organizational device 100 shown in FIG. 2, there are three binder units 200A-C attached, or to be attached, to the central panel 110; however, the central panel 110 may hold from one up to eight or more binder units. The binder units 200A-C may be made of any durable material, such as metal, wood or plastic. The binder units 200A-C preferably have tightly closable rings 220 with locking tabs 250 on each end.

Optionally included on the device 100 are a set of front feet 80A, 80B positioned along the bottom edge 18 and back feet 80C, 80D (hidden from view) positioned along a bottom edge 41 of the support member 40. The feet 80A-D may be formed from any suitable material, such as rubber.

As shown in FIG. 2, the binder unit 200 includes an attachment assembly 240 disposed on a portion of the back of the binder capable of removably attaching to the attachment assembly 50 on the central panel 110. The attachment assembly 240 on the binder unit 200 may include any suitable structure capable of interconnecting with a corresponding attachment assembly 50 included on the central panel 110 such as, for example, hook and loop fasteners such as Velcro®, magnetic elements, interlocking tabs,

In one embodiment, each binder unit 200 is fixedly attached to a member such as a bar with a fastener such as, for example, a screw, rivet, and the like. The attachment assembly 240, such as “eye-side” Velcro® is disposed on at least a portion of the other side of the bar. The Velcro® can be attached to the bar using any suitable adhesive. The Velcro® is preferably commercial grade and securely, but removably, attaches to the Velcro® “hook-side” of the central panel 110 as shown in FIG. 2. A description of a method of making one embodiment of the binder unit 200 is provided in Example 2 below.

FIG. 3 shows the interconnection between the major elements of a representative embodiment of the organizational device 100. As shown, the support member 40 is attached to the top edge 16 of the central panel 110 with interfacing hinge elements 60A and 60B that form a hinge 60. The hinge 60 is then secured with the insertion of a hinge pin 62. The support member 40 is reinforced by support arms 42 and 52 (hidden from view). The support arms 42, 52 each have a first end with a first hinge element 44, 54 that removably attaches to a corresponding first hinge element 72, 74 on the support member 40. The support arms 42, 52 each have a second end with a second hinge element 46, 56 that each removably attaches to a corresponding second hinge element 76, 78 located on the back side 14 of the central panel 110. For assembly, the corresponding hinge elements are aligned (e.g., 44 and 72), and a hinge pin 70 is placed through the hinge rings to secure the attachment. While the removable attachment elements are described in terms of hinge elements, other removable attachment means may be used such as, for example, interlocking tabs, snaps, zippers, and the like. In some embodiments, the support member 40, and/or the first end 44, 54 of the support arms 42, 52 are fixedly attached to the top edge 16 and the back side 14 of the central panel 110, respectively, to allow for ease of assembly of the device 100.

With continued reference to FIG. 3, in some embodiments, the organizational device 100 includes a detachable left wing panel 120 and right wing panel 130 that are each attached to the central panel 110. The wing panels 120, 130 may be attached to the central panel 110 with any suitable detachable structure, such as, for example, hook and loop fasteners such as Velcro®, magnetic elements, interlocking tabs, snaps, zippers, and the like. In one embodiment, the central panel 110 includes a first slot 22 adjacent the left edge 20 and a second slot 32 adjacent the right edge 30 that are each sized to receive a corresponding left wing tab 126 on the left wing panel 120 and a right wing tab 136 on the right wing panel 130, respectively. Each wing panel 120, 130 also includes a flange 124, 134 along the attachment edge in order to form a secure connection against the left and right edges of the central panel 110. Optionally included on the wing panels is a slot 132 for securing the wing panels with a cord or string (best shown in FIG. 1).

The base unit 10 and wings 120 and 130 may be made out of any durable stiff material such as, for example, metal, wood or plastic. An example of a method of assembling one embodiment of the base unit 10 and wings 120 and 130 is provided in Example 1. The base unit 10 and wings 120, 130 may be made in various dimensions and shapes.

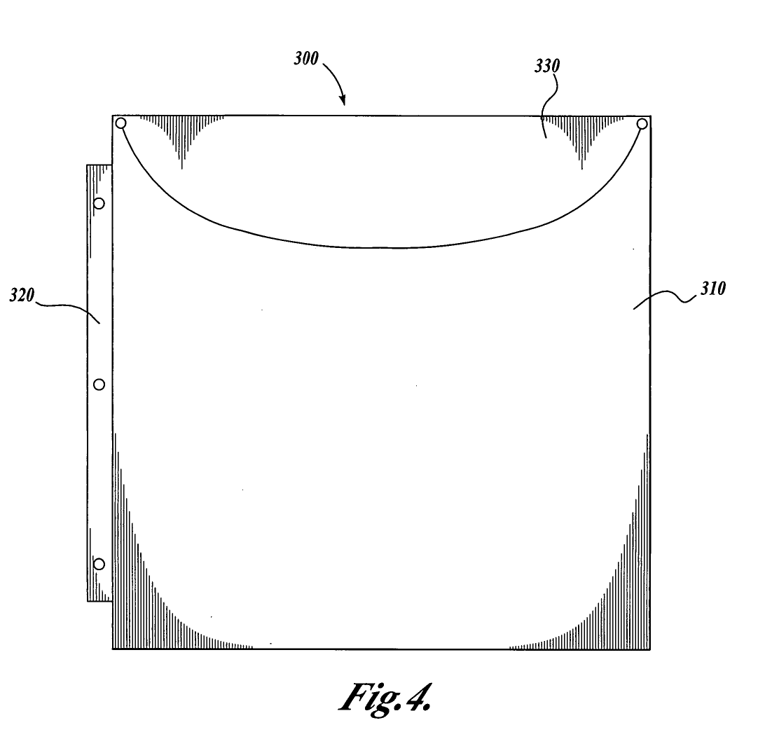

As shown in FIG. 2, the binder units 200A-C receive at least one storage page 300. As shown in more detail in FIG. 4, each storage page 300 is preferably rectangular in shape with a tab 320 on one side adapted with holes to be received in the binder unit 200 and includes at least one storage pocket 310 in which items can be stored. In one embodiment, the tab 320 includes at least two holes located at predetermined intervals that correspond to the spacing of the binder rings to allow the storage page 300 to be secured in the binder 200. The storage pocket 310 includes an opening that is covered with a crescent-shaped flap 330. The crescent-shaped flap 330 includes a rectangular top that is sized to align with the storage pocket, and includes a curved bottom edge as shown in FIG. 2. In some embodiments, the storage page 300 includes a perforation above and adjacent to the top of the crescent-shaped flap. The perforation allows the crescent-shaped flap 330 to be inserted therethrough such that the flap 330 can be folded behind the storage pocket 310 to allow ease of access to the pocket 310. The storage pocket 310 is preferably made of a transparent material, such as plastic, to allow the contents stored in the storage pocket to be easily viewed.

In operation, multiple storage pages 300 are received in the rings 220 of the binder unit 200 and locked into place with the locking tabs 250. A binder unit 200 loaded with storage pockets 300 can be easily attached and detached from the base unit 10 due to the Velcro® backing 50. By binding a number of storage pages 300 into a binder 200, the present invention can be used as a scrapbook or an organizational system for storing items such as craft supplies. As described above, multiple binders 200 can be added to one base unit 10 to increase the capacity of the organizational device. A single base unit 10 may be combined with two wings, or, alternatively, multiple base units 10 may be assembled and used in tandem with two wings attached to the outermost left and right edges of the outermost panels 110. The tilted angle of the base unit 10 helps to support the storage pages, allowing a user to more easily flip through the storage pages to find a stored item. In addition, the acute angle of the base unit 10 provides an organizational device 100 that can be used as a display that can be left open on a table or shelf to display the contents of a particular storage page.

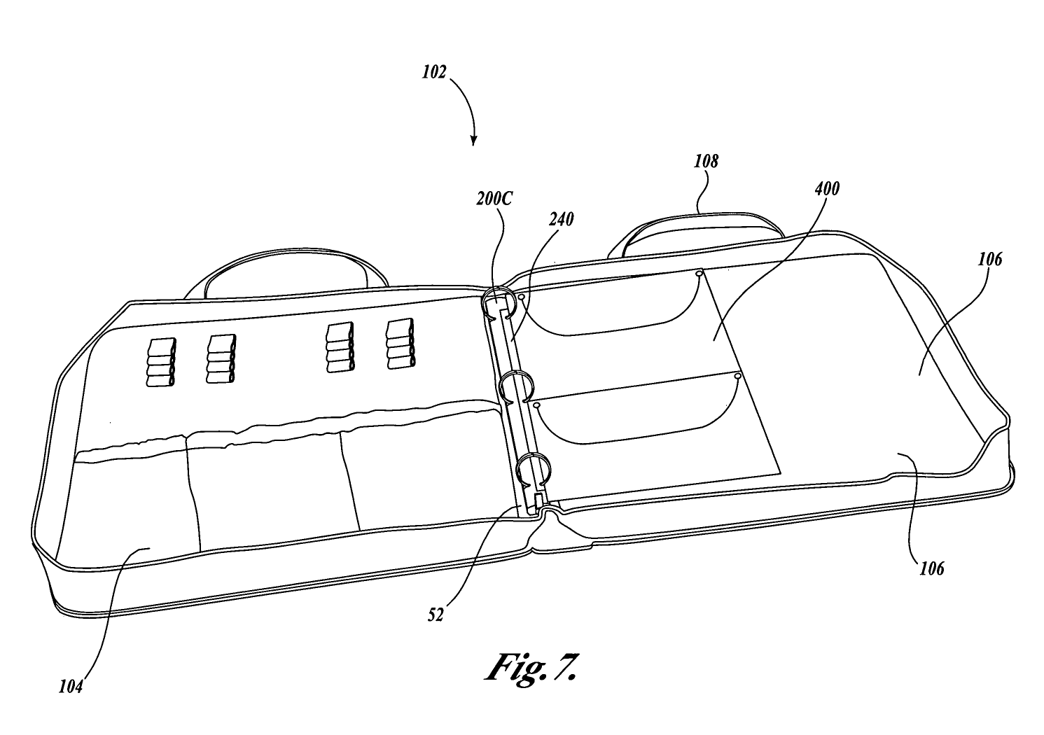

In another embodiment, an organizational device 102 useful for travel is provided that is capable of removably receiving and transporting one or more binders 200. FIG. 7 shows a representative embodiment of an organizational device 102 that includes a central panel 52, a left wing 104, and a right wing 106. Each wing 104, 106 is capable of folding towards the central panel 52 to form a compact organizational device 102. The organizational device 102 may also include a zipper (not shown) or other equivalent structure for securing the wings together. The central panel 52 includes means for removably attaching a binder unit 200C thereto. In the embodiment shown in FIG. 7, the central panel 52 includes a region of “hook-side” Velcro® (hidden from view) that allows the removable attachment of the binder 200C that includes the region of “eye-side” Velcro® 240 on the back thereof. The organizational device 102 may include other means for removably attaching the binder units 200 to the central panel 52, such as magnetic attachment elements, interlocking tabs, snaps, zippers, and the like. The organizational device 102 may also include one or more carrying straps 108 and may additionally include several travel pockets, as shown in FIG. 7. In operation of the organizational device 102, a binder unit, such as the binder unit 200C, is loaded with multiple storage pockets and the loaded binder 200C can be easily moved between the organizational device 100 and the organizational device 102, as desired.

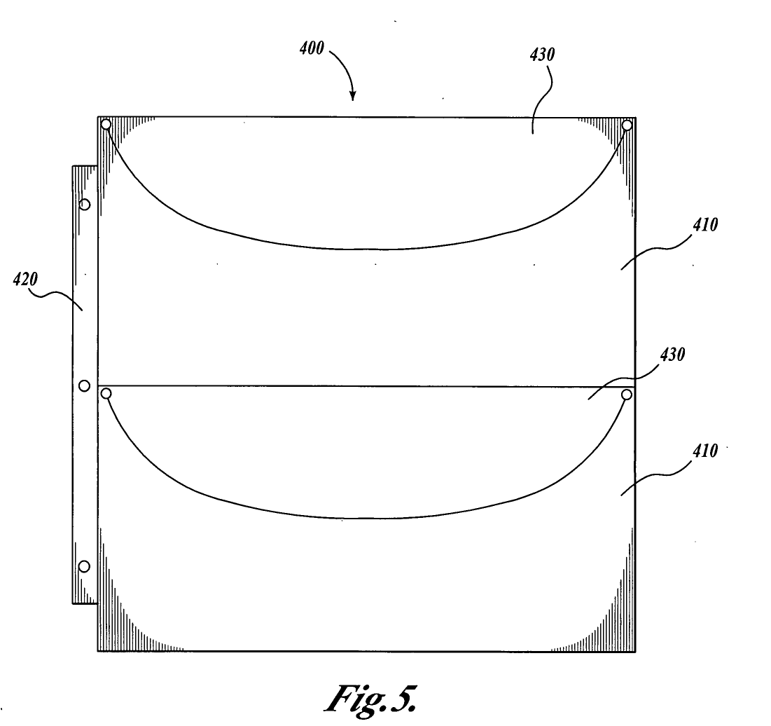

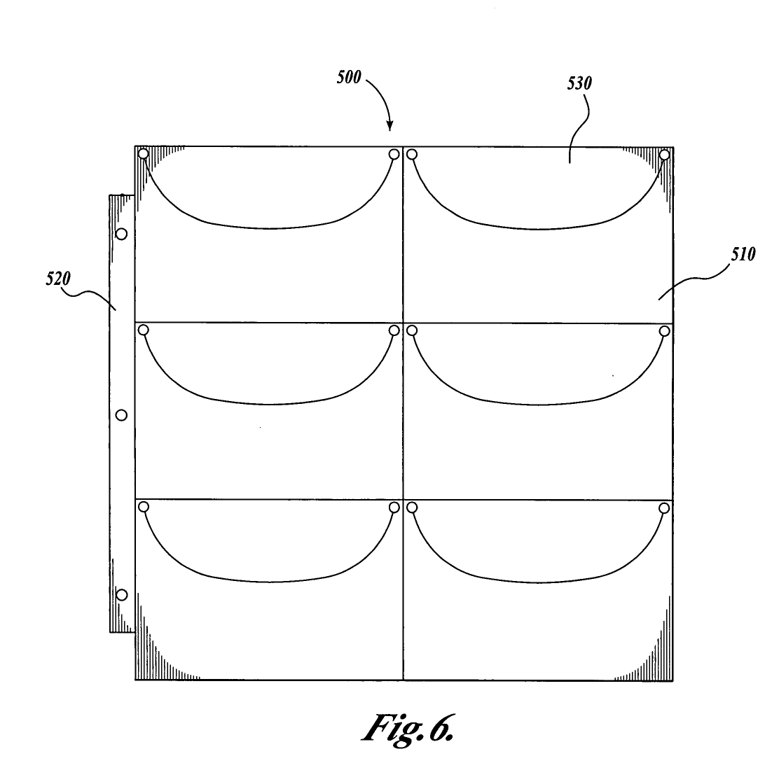

In another aspect, the invention provides a storage page 300 with a crescent-shaped flap 330 that secures the stored item in a storage pocket 310 as shown in FIG. 4. A tab 320 with holes having predetermined intervals that correspond to the binder rings is attached to the storage page 300 to allow the storage page to be bound into a binder via the binder rings, as described above. The crescent-shaped flap 330 provides for ease of loading and unloading and may be tucked behind a stored item, if desired. The storage pockets 300 with crescent-shaped flaps 330 may be made from any material that is durable, transparent, and acid free, such as, for example, food-grade plastic that is acid free and PVC free. In some embodiments, the storage page 300 has one large pocket for loading extra large items, as shown in FIG. 4. In another embodiment, a storage page 400 has two storage pockets 410, each having an individual crescent-shaped flap 430, as shown in FIG. 5. In yet another embodiment, a storage page 500 has six storage pockets 510, each having an individual crescent-shaped flap 530, as shown in FIG. 6. In another embodiment (not shown), the storage page has twelve storage pockets, each having an individual crescent-shaped flap. The storage pages with multiple pockets having crescent-shaped flaps may be of the same or different sizes and can be used with the organizational device 100 and the organizational device 102, described above.

In accordance with the present aspect of the invention, the storage pages may be made with different designs. Examples of useful designs include:
A. Super Sized Single—One larger than 12″×12″ pocket with a single large crescent-shaped flap.
B. Double Extra Long—Two 12″×6″ pockets, each having an independent crescent-shaped flap.
C. Perfect Six—Six 4″×6″ pockets, each having an independent crescent-shaped flap.
D. Dream Dozen—Twelve pockets, eight of which are 3″×3″ and four of which are 3″×6″. All twelve pockets have independent crescent-shaped flaps.

The storage pages may be assembled using any pliable but durable material including, but not limited to, canvas, plastic material, or any type of fabric that can be sewn or bonded together, as further described in Example 3 below.

The following examples merely illustrate the best mode currently contemplated for practicing the invention, but should not be construed to limit the invention.

### EXAMPLE 1

This example describes a method of making one embodiment of the base unit 10 that can be used to form the organizational device 100 of the invention.

Base Unit Construction:

The base unit 10 was constructed of powder coated steel and was assembled using the components illustrated in FIGS. 1-3 as described below.

Base Unit Parts List as Shown in FIGS. 1-3
1. Central Panel (110), steel, 15.75″L×13.5″H, 18 interlocking hinge rings at top with slots (22) and (32) cut in each side for wing (120), (130) mounting
2. Velcro® Fabric Panel (50), Hook Side, 13.75″ L×13.25″ W
3. Left Wing Panel (120), steel, 13 1/16″×11½″
4. Right Wing Panel (130), steel, 13 1/16″×11½″
5. Support member (40), 15.25″×6.75″, 19 interlocking hinge rings (60A) at the top
6. Long Hinge Pin (62) 15.75″ long, 1/16″ in diameter
7. Two (2) Back Support Arms (42), (52), steel, 8.25″×2.5″, with two interlocking hinge elements (44), (46) and (54), (56) at each end
8. Four (4) Back Support Hinges (72) and (74) for attachment on the support member (40) and (76), (78) for attachment on the back side (14) of the central panel (110)
9. Four (4) Short Hinge Pins (70), 2.5″ long, 1/16″ in diameter
10. Long Hinge Pin (62) 15.75″ long, 1/16″ in diameter, with the last 3 inches bent to form a hook

Steps for Assembly of the Base Unit (With Reference to the Above Parts List and as Shown in FIGS. 1-3)
1. Secure the hook-side Velcro® fabric panel (50) to the top side (12) of the central panel (110) using a commercial strength glue or epoxy. The glue should be spread on the backside of the Velcro® panel (50). The Velcro® panel (50) should cover the majority of the front of the central panel (110) leaving a gap of exposed metal approximately 0.25″ wide at the top and bottom and a gap of exposed metal approximately 1″ wide at the left and right sides (slots (22) and (32) on the left and right sides should not be covered with Velcro® fabric).
2. Adhere one (1) of the back support hinges (76) to the back left side of the central panel. The interlocking hinge rings should run parallel to the bottom edge of the panel and be 2.5″ from the left side of the central panel and 3.5″ from the bottom of the central panel. Repeat this procedure with another back support (78) on the right side of the back of the central panel.
3. Adhere one of the back support hinges (74) to the right side of the support member (40), 2.5″ from the left side of the support member and 1.5″ from the bottom edge of the support member. The hinge piece (74) should run parallel to the bottom edge of the support member. Repeat the same procedure with the final back support hinge (72) piece on the left side of the support member (40).
4. Line up the interlocking hinge rings (60A) at the top of the central panel (110) with the interlocking hinge rings (60B) on the support member (40) and slide them together to form a “tunnel,” insert the long Hinge Pin (62) through the tunnel and secure it by bending each end to form a hook.
5. Line up the interlocking hinge rings on one of the back supports (52) with the right side hinge mount interlocking rings on the central panel (110). Slide the rings together to form a “tunnel.” Slide a short hinge pin (70) through the tunnel and secure it by bending each end into a hook.
6. Line up the interlocking hinge rings on the right side of the back supports (42) with the interlocking hinge rings on the left side back support (40). Slide the pieces together to form a “tunnel.” Slide the long hinge pin (62) through the “tunnel.”
7. Line up the interlocking hinge rings on the left side of the back panel (52) with the interlocking hinge rings on the left side the back support (72). Slide them together to form a “tunnel.”
8. Continue to push the long hinge pin (62) through the second “tunnel” to form a secure attachment.
9. Turn the base unit (10) so it is resting on the 15.75″ long edge of the central panel (110) and the 15.75 inch long edge of the back panel with the long hinge section at the top and the Velcro® (50) front facing you.
10. Insert the tab on the left wing panel (126) through the slot (22) on the left side of the central panel.
11. Insert the tab on the right wing panel (136) through the slot (32) on the right side of the central panel.
   The base unit (10) with central panel (110) and wing panels (120), (130) is complete.

### EXAMPLE 2

This example describes a method of making one embodiment of the binder unit 200 that can be included in the organizational device 100.

Binder Construction:

The binder unit 200 may be a standard 3-ring or multi-ring mechanism which has been riveted to a steel bar. A piece of eye-side Velcro® is epoxied and riveted to the steel bar, allowing the binder to attach securely to the front or face of the base unit 10 (made as described in Example 1).

Binder Parts List as Shown in FIG. 5
1. One standard three (3) ring binder mechanism
2. One steel bar
3. One piece “eye-side” Velcro®
4. Two (2) single piece rivets

Binder Assembly (With Reference to the Above Binder Parts List)
1. Adhere the Velcro® to the steel bar using commercial-strength epoxy.
2. Secure the steel bar with the Velcro® to the standard 3-ring binder mechanism using the two rivets. The Velcro® side should be on the outside so that it becomes the base the binder will sit on.
   The binder unit is complete.

### EXAMPLE 3

This example describes a method of making one embodiment of a storage page with a crescent-shaped flap that can be used with the organizational device of the invention.

The Storage Pages

The storage pages are made of an acid-free, PVC-free, and photo-safe plastic which is preferably 9 mm thick.

Storage Pages Parts List

Each storage page is constructed using two identical sheets of plastic. The sheets are cut into the template shape, for example, as shown in FIGS. 4-6. Punch holes in the left side of each sheet as shown in FIGS. 4-6. These are standard three-hole punch dimensions.

To create each of the pages, using the templates shown in FIGS. 4-6 as follows:

Construction of a Super Sized Single storage sheet—One larger than 12″×12″ pocket with a single large crescent-shaped flap, as shown in FIG. 4.
1. Measure and cut the flap line on one sheet of plastic, which will be your top sheet for that page design.
2. Place the top sheet with the flap cut on top of another piece cut to the same template shape and size and punched with the standard 3-hole punch down the left-side column.
3. Line up the outside edges so the top and bottom sheets match perfectly.
4. Using a sewing machine or heat sealing device, sew or heat press the seam as shown in FIG. 4. These seams are represented as dotted lines on the drawings. The flaps are represented as solid lines drawn in the crescent shape.

To create additional storage pages, continue using the same procedure, cutting flaps and seaming edges according to FIGS. 4-6.

### EXAMPLE 4

This example describes the components and instructions provided in one embodiment of a kit form of the invention.

Kit Components:

(1) One base unit 10 (assembled as described in EXAMPLE 1, including a central panel with hinged support arms attached to the back side of the central panel, and a pre-attached hinged support member, and a Velcro® top);
(2) One left-side wing 120;
(3) One right-side wing 130;
(4) One shepherd's hook 62;
(5) At least one binder unit 200, assembled as described in EXAMPLE 2;
(6) At least one storage page with crescent-shaped flaps as described in EXAMPLE 3; and
(7) Printed instructions for assembly may also be included, as described below:

Assembly Instructions for the ScrapRack Kit

1. Unpack your ScrapRack Kit. You will have three pieces: Left Wing; Base Unit and Right Wing. You will also have at least one binder and multiple storage pages.

2. Unfold the hinged support member from the central panel on the base unit. Locate and remove the silver hook that is threaded through the hinge elements on the back side of the central panel.

3. Keeping the support member face down on a solid surface, tilt the central panel up creating an angle and allow the pre-attached hinged support legs to drop into alignment with the attachment elements on the support member.

4. Insert the hinge pin through the aligned hinge elements to secure the support arms.

5. Tilt the base unit into position with the four rubber feet on the table, and the Velcro®-covered surface facing you. The long hinge should be located at the top of the base unit.

6. Insert the left-wing tab into the slot on the left and the right-wing tab into the slot on the right.

7. Open the rings on a binder unit by pressing the locking tabs down and load with one or more storage pockets. Close the rings by pushing the locking tabs up and place the Velcro®-covered spine of the binder onto the Velcro®-covered central panel of the base unit.

8. To remove the binder from the base unit, slide a flat edge (such as a ruler or pencil) between the Velcro® surfaces and lift from either end.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. An organizational device, comprising:
a base unit comprising a panel having a front surface, a back surface, a top edge, a bottom edge, a left-side edge and a right-side edge;
an attachment assembly for removably securing at least one binder unit to the front surface of the panel; and
at least one binder unit removably secured to the front surface of the panel.

2. The organizational device of claim 1, further comprising a support member attached to the panel, the support member capable of supporting the panel at an acute angle.

3. The organizational device of claim 1, further comprising a left-wing panel and a right-wing panel detachably attached to the left-side edge and the right-side edge of the panel, respectively.

4. The organizational device of claim 2, wherein the left-wing panel and the right-wing panel are each substantially rectangular in shape and sized to form a surface in the same plane as the front surface of the panel when in an open position.

5. The organization device of claim 1, wherein the attachment assembly for removably securing the binder unit to the panel includes a region of hook-side Velcro® disposed over a portion of the front surface of the panel and a region of eye-side Velcro® disposed over a portion of the back surface of the at least one binder unit.

6. The organizational device of claim 1, wherein the at least one binder unit comprises multiple rings capable of securing a plurality of storage pages.

7. The organizational device of claim 6, further comprising at least one storage page received in the at least one binder unit.

8. The organizational device of claim 7, wherein the at least one storage page includes a storage pocket covered with a crescent-shaped flap.

9. An organizational device comprising:
a central panel having a front surface, a back surface, a top edge, a bottom edge, a left-side edge, and a right-side edge; wherein the central panel includes means for removably attaching at least one binder unit to the front surface thereof; and
a left-wing panel and a right-wing panel attached to the central panel.

10. The organizational device of claim 9, further comprising at least one binder unit removably attached to the front surface of the central panel.

11. The organizational device of claim 10, wherein the at least one binder unit comprises multiple rings capable of securing a plurality of storage pages.

12. The organizational device of claim 11, further comprising at least one storage page received in the at least one binder unit.

13. A kit for making an organizational device, the kit comprising:
(1) a base unit comprising a central panel having a front surface, a back surface, a top edge, a bottom edge, a left-side edge, and a right-side edge; wherein the central panel includes means for removably securing at least one binder unit to the front surface thereof;
(2) a left-side wing panel with attachment means for removably attaching to the central panel;
(3) a right-side wing panel with attachment means for removably attaching to the central panel;
(4) at least one binder unit comprising one or more rings capable of securing one or more storage pages, wherein the back portion of the at least one binder unit includes means for removably securing the binder unit to the central panel; and
(5) a plurality of storage pages adapted to be received in the at least one binder unit.

14. The kit of claim 13, wherein the kit includes a support member adapted to attach to the central panel, wherein the support member is capable of supporting the central panel at an acute angle.

15. A kit for making an organizational device, the kit comprising:
(1) a base unit comprising a central panel having a front surface, a back surface, a top edge, a bottom edge, a left-side edge, and a right-side edge, wherein the central panel includes hook-side Velcrog for removably securing at least one binder unit to the front surface thereof;
(2) a left-side wing panel with attachment means for removably attaching to the central panel;
(3) a right-side wing panel with attachment means for removably attaching to the central panel;
(4) at least one binder unit comprising multiple rings capable of securing a plurality of storage pages, wherein the back surface of at the least one binder unit includes a region of eye-side Velcro® capable of removably securing the binder unit to the central panel; and
(5) a plurality of storage pages adapted to be received in the at least one binder unit.

16. The kit of claim 15, wherein the kit includes a support member adapted to attach to the central panel, wherein the support member is capable of supporting the central panel at an acute angle.

17. The kit of claim 15, wherein the plurality of storage pages include at least one storage page comprising a storage pocket covered with a crescent-shaped flap.

18. A storage page comprising at least one storage pocket and at least one crescent-shaped flap, wherein the crescent-shaped flap secures a stored item in the storage pocket.

19. The storage page of claim 18, further comprising a tab with holes formed at predetermined intervals capable of being received in a multi-ring binder.
